(19) United States
(12) Patent Application Publication
(10) Pub. No.: US 2025/0183743 A1
(43) Pub. Date: Jun. 5, 2025

(54) ARMATURE AND ROTATING ELECTRIC MACHINE

(71) Applicant: DENSO CORPORATION, Kariya-city (JP)

(72) Inventors: Ryoji UEJI, Kariya-city (JP); Satoshi Annen, Kariya-city (JP)

(73) Assignee: DENSO CORPORATION, Kariya-city (JP)

(21) Appl. No.: 19/049,596

(22) Filed: Feb. 10, 2025

Related U.S. Application Data
(63) Continuation of application No. PCT/JP2023/014640, filed on Apr. 10, 2023.

(30) Foreign Application Priority Data
Aug. 9, 2022 (JP) 2022-127360

(51) Int. Cl. H02K 3/18; H02K 3/28; H02K 3/52

(52) U.S. Cl. CPC H02K 3/18; H02K 3/28; H02K 3/52

(57) ABSTRACT

A stator includes a stator core having a plurality of teeth, and a plurality of coils formed respectively around the teeth. Portions of a winding, which forms the coils, constitute inter-coil connection portions that connect the coils. A first end portion and a second end portion, which are respectively one end portion and the other end portion of the winding, are led out, respectively from a second circumferential side and a first circumferential side in the coil formed around a predetermined one of the teeth, toward a first side in an axial direction. Moreover, the numbers of electrical conductor portions in the respective coils are set to be equal to each other; the electrical conductor portions are portions of the winding which form the coils and are routed in the axial direction along the teeth.

### CROSS-REFERENCE TO RELATED APPLICATIONS

The present application is a continuation application of International Application No. PCT/JP2023/014640 filed on Apr. 10, 2023, which is based on and claims priority from Japanese Patent Application No. 2022-127360 filed on Aug. 9, 2022. The entire contents of these applications are incorporated by reference into the present application.

### BACKGROUND

### 1 Technical Field

The present disclosure relates to armatures and rotating electric machines.

### 2 Description of Related Art

There is known, for example as disclosed in Japanese Patent Application Publication No. JP 2013-162726 A, a stator that is employed in a brushless motor. The stator includes a core having a plurality of teeth, and an insulator mounted to the core. Moreover, the stator also includes a plurality of coils formed by winding an electroconductive winding around respective ones of the teeth. Furthermore, first and second end portions of the winding that forms the coils are led out to one axial side respectively from different ones of the coils.

### SUMMARY

In terms of achieving reduction in the sizes of those parts of the stator to which the first and second end portions of the winding that forms the coils are connected, it is desirable to aggregate the first and second end portions of the winding. In this regard, there is room for improvement in the configuration of the known stator described above.

The present disclosure has been accomplished in view of the above circumstances.

According to a first aspect of the present disclosure, there is provided an armature which includes: an armature core having a plurality of teeth arranged at intervals in a circumferential direction; a plurality of coils formed by winding an electroconductive winding around each of the teeth; inter-coil connection portions that are portions of the winding which connect the coils; a first end portion and a second end portion which are respectively one end portion and the other end portion of the winding, the first and second end portions being led out, respectively from a second circumferential side and a first circumferential side in the coil formed around a predetermined one of the teeth, toward a first side in an axial direction; and a plurality of electrical conductor portions that are portions of the winding which form the coils and are routed in the axial direction along the teeth, wherein the numbers of the electrical conductor portions in the respective coils are set to be equal to each other. Moreover, according to a second aspect of the present disclosure, there is provided a rotating electric machine which includes a stator and a rotor. One of the stator and the rotor includes an armature and the other of the stator and the rotor has a magnet arranged to radially face the armature, wherein the armature includes: an armature core having a plurality of teeth arranged at intervals in a circumferential direction; a plurality of coils formed by winding an electroconductive winding around each of the teeth; inter-coil connection portions that are portions of the winding which connect the coils; a first end portion and a second end portion which are respectively one end portion and the other end portion of the winding, the first and second end portions being led out, respectively from a second circumferential side and a first circumferential side in the coil formed around a predetermined one of the teeth, toward a first side in an axial direction; and a plurality of electrical conductor portions that are portions of the winding which form the coils and are routed in the axial direction along the teeth, wherein the numbers of the electrical conductor portions in the respective coils are set to be equal to each other.

With the above configuration, it becomes possible to effectively aggregate one end portion and the other end portion of the winding that forms the coils.

### BRIEF DESCRIPTION OF THE DRAWINGS

FIG. 1 is a schematic diagram showing a cross section, taken along an axial direction, of a motor according to a first embodiment.

FIG. 2A is another schematic diagram showing a cross section, taken along the axial direction, of the motor according to the first embodiment and illustrating a state of the motor before a rotor is assembled to a housing.

FIG. 2B is a perspective view showing the housing and a stator fixed to the housing.

FIG. 2C is a partially cross-sectional side view showing the housing and the stator fixed to the housing.

FIG. 3A is a plan view of the stator as seen from a first axial side.

FIG. 3B is a side view of the stator as seen from a radially outer side.

FIG. 4A is an exploded perspective view of the stator constituent parts of respective phases as seen from a second axial side.

FIG. 4B is a perspective view of the U-phase stator constituent part as seen from the second axial side.

FIG. 4C is a bottom view of the U-phase stator constituent part as seen from the second axial side.

FIG. 4D is a perspective view of U-phase core constituent parts and a U-phase insulator as seen from the second axial side.

FIG. 5 is a perspective view of the U-phase stator constituent part as seen from the first axial side, showing in a magnified manner a U-phase coil, from which both a first end portion and a second end portion are led out, and its surroundings.

FIG. 6 is a plan view showing in a magnified manner a part of an insulator which supports a core constituent part.

FIG. 7A is a schematic diagram showing U-phase teeth of a stator core and U-phase coils formed respectively around the U-phase teeth.

FIG. 7B is a schematic diagram showing the manner in which all the coils of the stator are connected together.

FIG. 8 is a schematic diagram showing U-phase teeth of a stator core and U-phase coils formed respectively around the U-phase teeth in a motor according to a second embodiment, illustrating a state of a winding, which forms the U-phase coils, being wound around each of the U-phase teeth of the stator core.

FIG. 9 is a schematic diagram, which corresponds to FIG. 7A, showing the U-phase teeth of the stator core and the U-phase coils formed respectively around the U-phase teeth in the motor according to the second embodiment.

### DESCRIPTION OF EMBODIMENTS

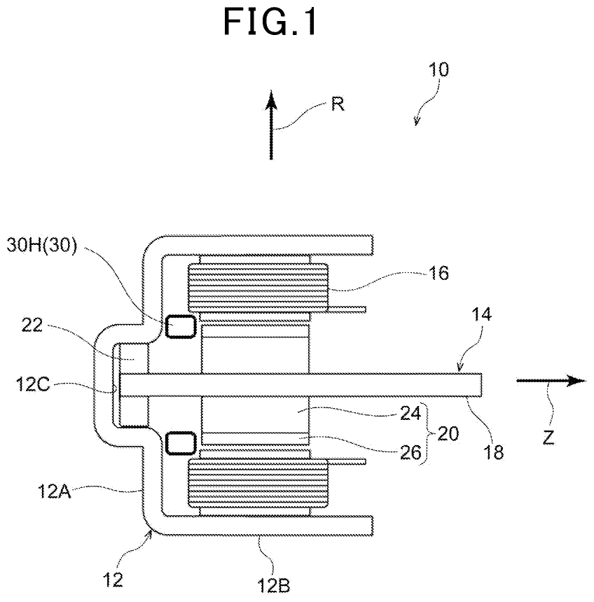

A motor 10 according to a first embodiment of the present disclosure will be described with reference to FIGS. 1 to 7B. It should be noted that the arrows Z, R and C suitably shown in the drawings respectively indicate a first side in a rotation axial direction, the outer side in a rotation radial direction and a first side in a rotation circumferential direction of a rotor 14 that will be described later. Moreover, in the case of merely indicating the axial direction, the radial direction and the circumferential direction, unless specified otherwise, the arrows Z, R and C respectively indicate the rotation axial direction, the rotation radial direction and the rotation circumferential direction of the rotor 14. In addition, the motor 10 according to the present embodiment is an example of a rotating electric machine.

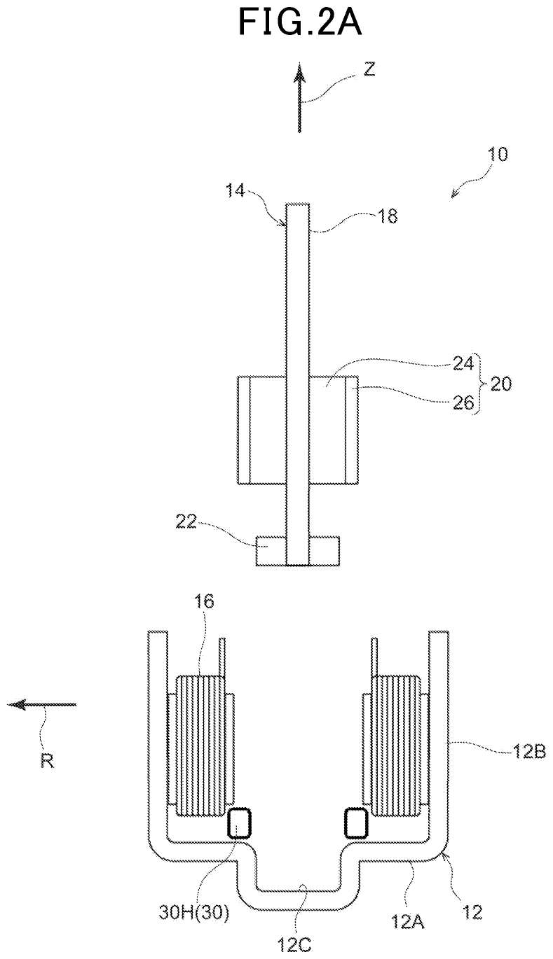

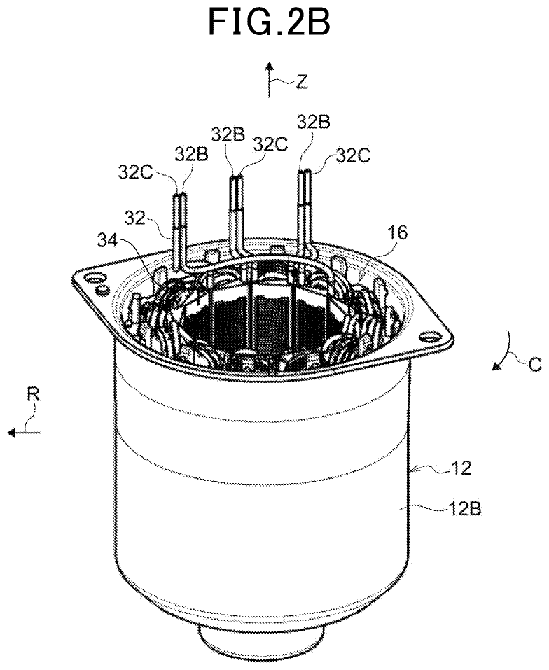

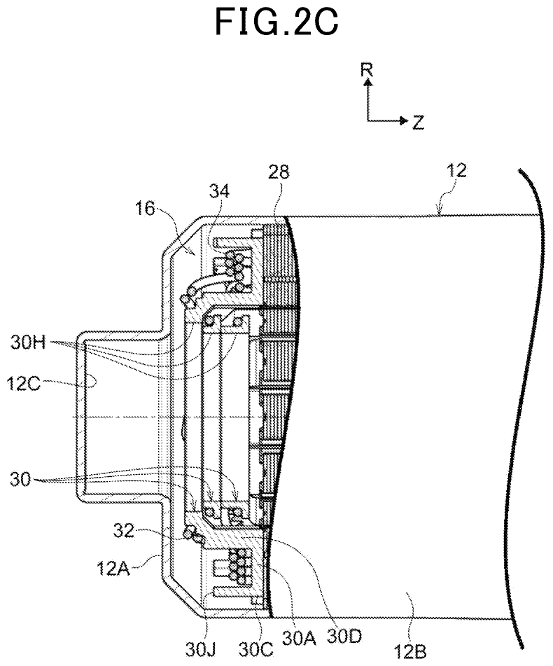

As shown in FIGS. 1, 2A, 2B and 2C, the motor 10 according to the present embodiment is configured as an inner rotor type brushless motor in which a rotor 14 is arranged radially inside a stator 16 that serves as an armature. The motor 10 includes a housing 12, the rotor 14 supported by the housing 12, and the stator 16 fixed to the housing 12.

The housing 12 may be formed of, for example, steel. The housing 12 is formed in a bottomed cylindrical shape that is open on the first axial side and closed on the second axial side. Specifically, as shown in FIGS. 1, 2A and 2C, the housing 12 has a bottom wall 12A formed in a discoid shape whose thickness direction coincides with the axial direction, and a circumferential wall 12B formed in a cylindrical shape and extending from a radially outer end of the bottom wall 12A toward the first side in the axial direction. In a radially central part of the bottom wall 12A, there is formed a bearing engagement recess 12C that is recessed toward the second side in the axial direction.

As shown in FIGS. 1 and 2A, the rotor 14 includes a rod-shaped rotating shaft 18 and a rotor main body 20 fixed to the rotating shaft 18. To an end portion of the rotating shaft 18 on the second axial side, there is fixed an inner ring of a bearing 22 such as a rolling bearing. Moreover, an outer ring of the bearing 22 engages with the bearing engagement recess 12C of the housing 12, whereby the rotating shaft 18 is rotatably supported by the housing 12. That is, the rotor 14 is rotatably supported by the housing 12. The rotor main body 20 includes a rotor core 24 fixed to the rotating shaft 18 and magnets 26 fixed to an outer circumferential surface of the rotor core 24. The rotor core 24 is formed into a cylindrical shape by laminating a plurality of steel sheets in the axial direction. The rotating shaft 18 is press-fitted in a radially central part of the rotor core 24. Consequently, the rotor core 24 and the rotating shaft 18 are fixed to each other. To the radially outer surface of the rotor core 24, there are fixed the plurality of magnets 26. More particularly, in the present embodiment, eight magnets 26 are fixed to the radially outer surface of the rotor core 24. Moreover, those magnets 26 whose radially outer surfaces form N poles and those magnets 26 whose radially outer surfaces form S poles are arranged alternately in the circumferential direction. It should be noted that the number of the magnets 26 may be suitably set taking into account, for example, the output required of the motor 10.

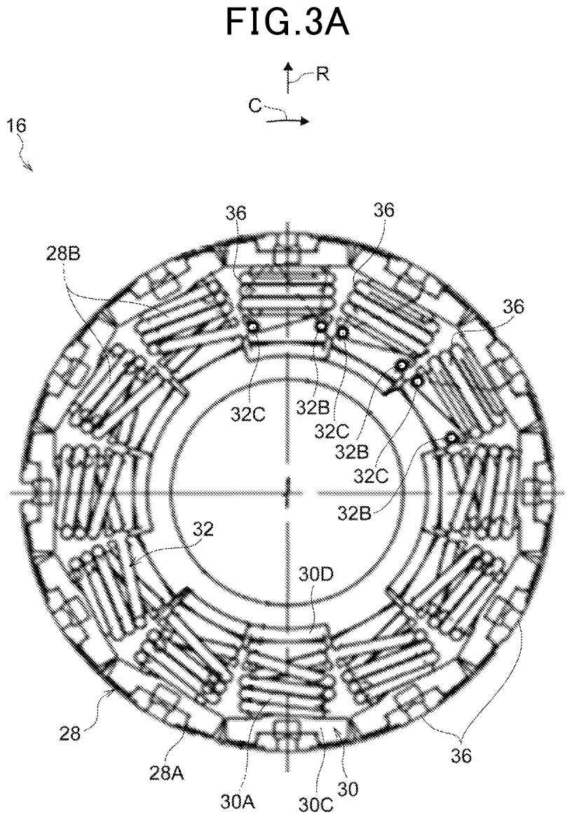

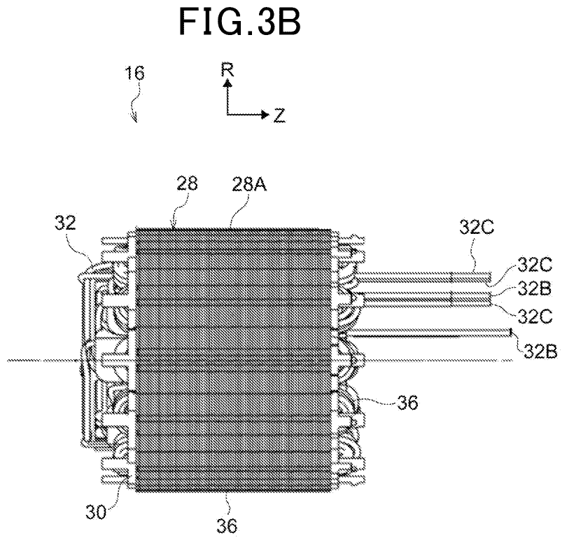

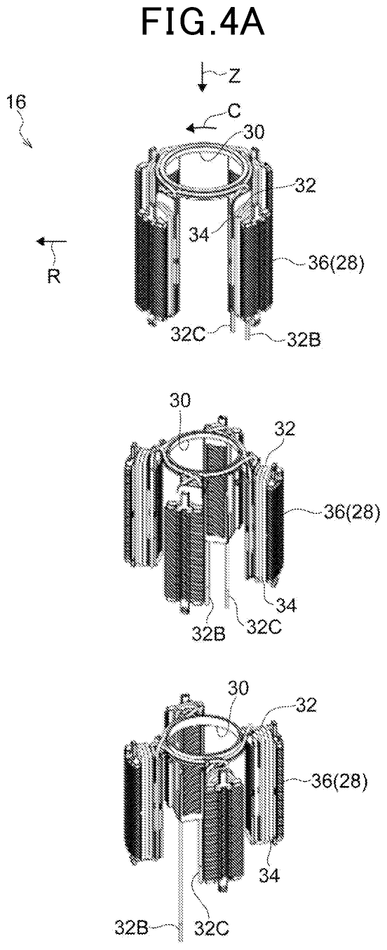

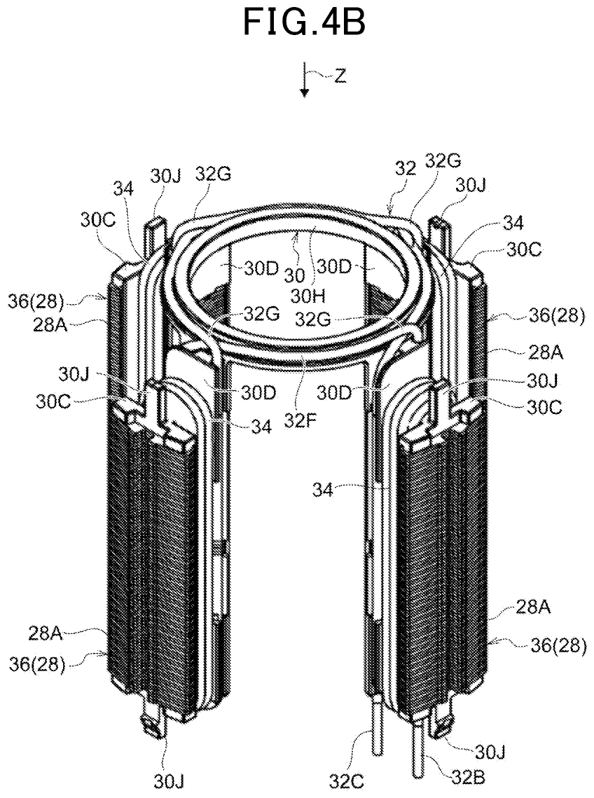

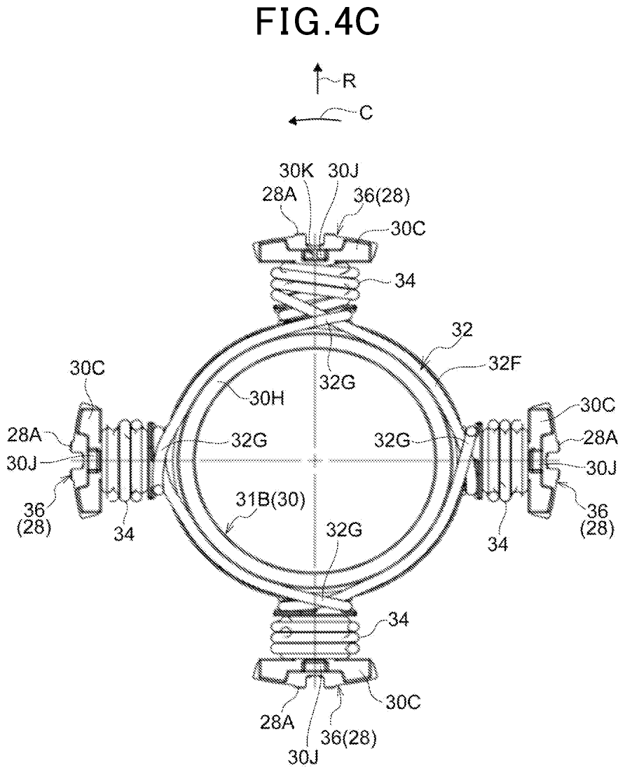

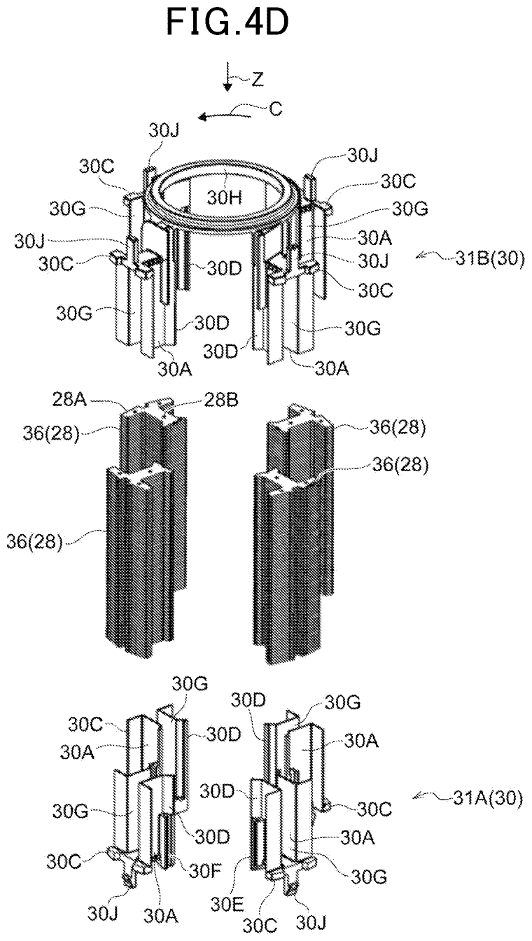

As shown in FIGS. 3A to 4D, the stator 16 includes a stator core 28 that serves as an armature core, insulators 30 mounted to the stator core 28, and a plurality of coils 34 formed by winding electroconductive windings 32 around the stator core 28.

The stator core 28 is formed by laminating a plurality of soft-magnetic metal sheets (e.g., steel sheets) in the axial direction. The stator core 28 has an annular part 28A formed (or arranged) in an annular shape, and a plurality of teeth 28B protruding radially inward from the annular part 28A. More particularly, in the present embodiment, the stator core 28 has twelve teeth 28B that are arranged at equal angular intervals in the circumferential direction. As shown in FIG. 3A and FIGS. 4A to 4D, in the present embodiment, the stator core 28 is segmented in the circumferential direction at center positions between circumferentially adjacent teeth 28B. Hereinafter, those parts into which the stator core 28 is segmented in the circumferential direction will be referred to as the core constituent parts 36. In the present embodiment, the stator core 28 is constituted of twelve core constituent parts 36. Each of the core constituent parts 36 includes a portion of the annular part 28A and one of the teeth 28B.

As shown in FIGS. 4A and 4D, in the present embodiment, the stator 16 includes three insulators 30 that respectively correspond to a U phase, a V phase and a W phase. The insulators 30 may be formed of, for example, an electrically-insulative resin material. The three insulators 30 are each bisected in the axial direction, and are respectively mounted to the four U-phase core constituent parts 36 having the respective U-phase teeth 28B on which U-phase coils 34 (to be described later) are respectively formed, the four V-phase core constituent parts 36 having the respective V-phase teeth 28B on which V-phase coils 34 (to be described later) are respectively formed and the four W-phase core constituent parts 36 having the respective W-phase teeth 28B on which W-phase coils 34 (to be described later) are respectively formed. Hereinafter, for each of the insulators 30 bisected in the axial direction, that part of the insulator 30 which is on the first axial side will be referred to as the first insulator part 31A; and that part of the insulator 30 which is on the second axial side will be referred to as the second insulator part 31B. Moreover, as shown in FIG. 4D, the first and second U-phase insulator parts 31A and 31B are mounted to the four U-phase core constituent parts 36 so as to have the four U-phase core constituent parts 36 sandwiched therebetween in the axial direction. Similarly, the first and second V-phase insulator parts 31A and 31B are mounted to the four V-phase core constituent parts 36 so as to have the four V-phase core constituent parts 36 sandwiched therebetween in the axial direction; and the first and second W-phase insulator parts 31A and 31B are mounted to the four W-phase core constituent parts 36 so as to have the four W-phase core constituent parts 36 sandwiched therebetween in the axial direction.

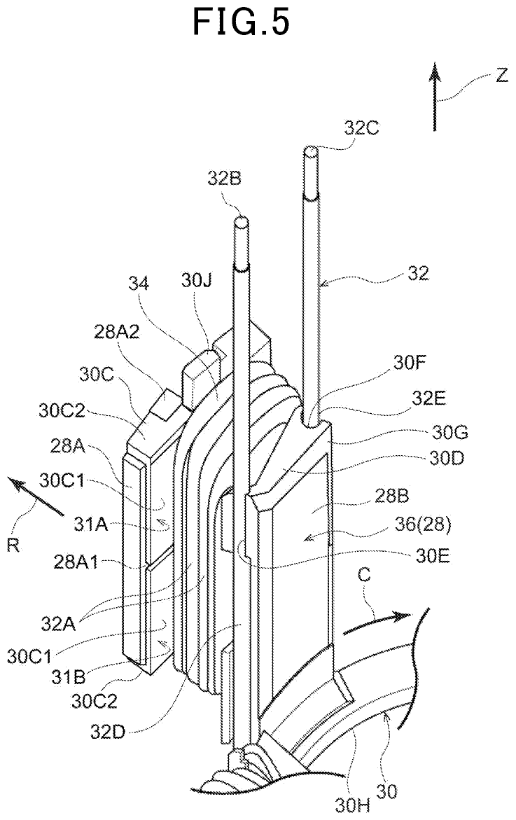

FIGS. 4B to 4D and FIG. 5 show the U-phase insulator 30 to which are mounted the four U-phase core constituent parts 36 having the respective U-phase teeth 28B on which the U-phase coils 34 are respectively formed. As shown in these figures, the four U-phase core constituent parts 36 are mounted to the single U-phase insulator 30; and the U-phase coils 34 are respectively wound around the U-phase teeth 28B of the four U-phase core constituent parts 36.

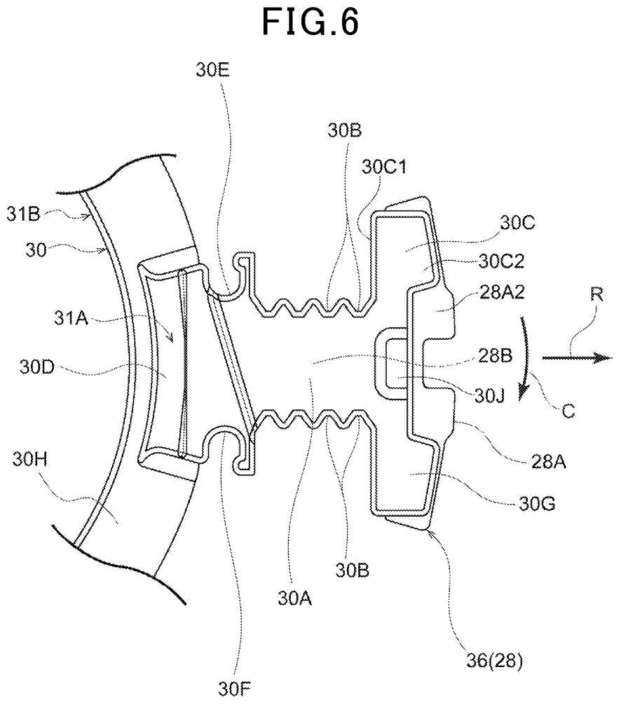

As shown in FIG. 6, a part of an insulator 30 which corresponds to one core constituent part 36 has a bobbin portion 30A covering most of the teeth 28B of the core constituent part 36; the core constituent part 36 is formed by laminating a plurality of steel sheets as described above. A coil 34 is formed by winding a winding 32 (see FIG. 5) around the bobbin portion 30A. On both circumferential sides of the bobbin portion 30A, there are formed, along the axial direction, a plurality of fitting grooves 30B into which portions of the winding 32 are respectively fitted to suppress radial displacement of the winding 32.

Moreover, the part of the insulator 30 also has an outer covering portion 30C arranged along a radially inner surface 28A1 and both axial end surfaces 28A2 of that portion of the annular part 28A of the stator core 28 which is included in the core constituent part 36. The outer covering portion 30C covers most of the radially inner surface 28A1 and most of both the axial end surfaces 28A2 of that portion of the annular part 28A which is included in the core constituent part 36. Hereinafter, depending on the situation, that part of the outer covering portion 30C which covers the radially inner surface 28A1 of the portion of the annular part 28A will be referred to as the first outer covering portion 30C1; those parts of the outer covering portion 30C which respectively cover the axial end surfaces 28A2 of the portion of the annular part 28A will be referred to as the second outer covering portions 30C2.

Furthermore, as shown in FIGS. 5 and 6, the part of the insulator 30 also has a flange portion 30D that covers a radially inner end portion of the tooth 28B of the core constituent part 36. The flange portion 30D protrudes, on the radially inner side of the bobbin portion 30A, toward the first circumferential side (i.e., in the direction indicated by the arrow C), toward the second circumferential side (i.e., in the direction opposite to the arrow C), toward the first axial side (i.e., in the direction indicated by the arrow Z) and toward the second axial side (i.e., in the direction opposite to the arrow Z).

Furthermore, the part of the insulator 30 also has central protrusions 30J that protrude, respectively from a circumferential central part of the second outer covering portion 30C2 on the first axial side and a circumferential central part of the second outer covering portion 30C2 on the second axial side, respectively toward the first axial side and the second axial side.

As already described, each of the insulators 30 of respective phases has a segmented structure including a first insulator part 31A and a second insulator part 31B. Therefore, each of the first insulator part 31A and the second insulator part 31B can be regarded as including the bobbin portion 30A, the outer covering portion 30C, the flange portion 30D and the central protrusions 30J described above.

In the first insulator part 31A, the bobbin portion 30A, the outer covering portion 30C and the flange portion 30D which together cover one core constituent part 36 can be regarded as together constituting an insulator main body portion 30G; and then the first insulator part 31A of each phase can be regarded as having four insulator main body portions 30G. Similarly, in the second insulator part 31B, the bobbin portion 30A, the outer covering portion 30C and the flange portion 30D which together cover one core constituent part 36 can be regarded as together constituting an insulator main body portion 30G; and then the second insulator part 31B of each phase can be regarded as having four insulator main body portions 30G.

Hereinafter, the specific configurations of the first insulator part 31A and the second insulator part 31B will be described.

At an end of the flange portion 30D of the first insulator part 31A on the second circumferential side, there is formed, along the axial direction, a first winding locking portion 30E as a winding locking portion that is open on the second circumferential side. Moreover, at an end of the flange portion 30D of the first insulator part 31A on the first circumferential side, there is formed, along the axial direction, a second winding locking portion 30F as a winding locking portion that is open on the first circumferential side. To the first winding locking portion 30E and the second winding locking portion 30F, there are respectively locked portions of the winding 32 along the axial direction.

The second insulator part 31B has an annular connection portion 30H that connects the four insulator main body portions 30G of the second insulator part 31B in the circumferential direction. The annular connection portion 30H is formed in an annular shape having its inner diameter set to be smaller than an outer diameter of the rotor main body 20 (see FIG. 2A). The annular connection portion 30H is located on the second axial side of the four insulator main body portions 30G of the second insulator part 31B. Moreover, the annular connection portion 30H is connected with second-axial-side parts of the flange portions 30D of the four insulator main body portions 30G of the second insulator part 31B. As shown in FIG. 4B, the four U-phase core constituent parts 36, which have the respective U-phase teeth 28B on which the U-phase coils 34 are respectively formed, are connected by the annular connection portion 30H of the U-phase insulator 30 (more specifically, of the U-phase second insulator part 31B). Consequently, the four U-phase core constituent parts 36, which have the U-phase insulator 30 mounted thereto, are arranged at equal intervals (more specifically, at equal angular intervals) in the circumferential direction.

As shown in FIG. 4C, a slit groove 30K is formed in a second-axial-side end portion of one of the four central protrusions 30J of the second insulator part 31B. More specifically, the slit groove 30K is formed in a circumferentially central part of the second-axial-side end portion of the central protrusion 30J, and is formed in a U-shape that is open on the second axial side when viewed in the radial direction.

As shown in FIG. 4A, the V-phase insulator 30, which is mounted to the four V-phase core constituent parts 36 having the respective V-phase teeth 28B on which the V-phase coils 34 are respectively formed, is configured similarly to the U-phase insulator 30 that is mounted to the four U-phase core constituent parts 36 having the respective U-phase teeth 28B on which the U-phase coils 34 are respectively formed. Moreover, the W-phase insulator 30, which is mounted to the four W-phase core constituent parts 36 having the respective W-phase teeth 28B on which the W-phase coils 34 are respectively formed, is also configured similarly to the U-phase insulator 30 that is mounted to the four U-phase core constituent parts 36 having the respective U-phase teeth 28B on which the U-phase coils 34 are respectively formed. In addition, as shown in FIGS. 2C and 3B, in a state where the assembly of the stator 16 has been completed, the annular connection portions 30H of the three insulators 30 are located overlapping each other in the axial direction, whereas all the teeth 28B are located at the same axial position.

As shown in FIG. 5, the four U-phase coils 34 are formed of a single winding 32 (i.e., a single continuous electrical conductor). The winding 32 is continuously wound around each of the U-phase teeth 28B of the four U-phase core constituent parts 36 that are supported by the U-phase insulator 30, thereby forming the four U-phase coils 34.

Similarly, the four V-phase coils 34 are also formed of a single winding 32 (i.e., a single continuous electrical conductor). The winding 32 is continuously wound around each of the V-phase teeth 28B of the four V-phase core constituent parts 36 that are supported by the V-phase insulator 30, thereby forming the four V-phase coils 34. Moreover, the four W-phase coils 34 are also formed of a single winding 32 (i.e., a single continuous electrical conductor). The winding 32 is continuously wound around each of the W-phase teeth 28B of the four W-phase core constituent parts 36 that are supported by the W-phase insulator 30, thereby forming the four W-phase coils 34. In addition, in the state where the assembly of the stator 16 has been completed, all of the U-phase coils 34, the V-phase coils 34 and the W-phase coils 34 are arranged sequentially along the circumferential direction.

Next, the detailed configuration of the stator 16 according to the present embodiment will be described.

In FIG. 5, there is shown one coil 34. Here, the coil 34 denotes that part of the winding 32 which is wound around one tooth 28B. Moreover, those portions of the winding 32 which form the coil 34 and are routed in the axial direction along the tooth 38B will be referred to as the electrical conductor portions 32A hereinafter. The electrical conductor portions 32A extend substantially straight in the axial direction on the first and second circumferential sides of the tooth 28B.

Furthermore, one end portion and the other end portion of the winding 32 which are led out, respectively from the second circumferential side and the first circumferential side in the coil 34 formed around a predetermined one of the teeth 28B (i.e., the tooth 28B shown in FIG. 5), toward the first side in the axial direction will be respectively referred to as the first end portion 32B and the second end portion 32C hereinafter. In addition, as shown in FIGS. 4C and 5, both the first end portion 32B and the second end portion 32C are led out from the same coil 34 that is formed at a position corresponding to the central protrusion 30J in which the slit groove 30K is formed.

Moreover, as shown in FIG. 5, that portion of the winding 32 which is adjacent to the first end portion 32B and locked to the first winding locking portion 30E of the insulator 30 will be referred to as the first locked portion 32D. Similarly, that portion of the winding 32 which is adjacent to the second end portion 32C and locked to the second winding locking portion 30F of the insulator 30 will be referred to as the second locked portion 32E. It should be noted that both the first locked portion 32D and the second locked portion 32E are included in the coil 34. Moreover, each of the first locked portion 32D and the second locked portion 32E constitutes one of the electrical conductor portions 32A. With the first locked portion 32D of the winding 32 locked to the first winding locking portion 30E of the insulator 30, the first end portion 32B of the winding 32 is located at a predetermined position and the posture of the first end portion 32B is maintained. Similarly, with the second locked portion 32E of the winding 32 locked to the second winding locking portion 30F of the insulator 30, the second end portion 32C of the winding 32 is located at a predetermined position and the posture of the second end portion 32C is maintained. It should be noted that although FIG. 5 shows the first end portion 32B and the second end portion 32C extending straight in the axial direction, the first end portion 32B and the second end portion 32C may alternatively be bent radially outward.

As shown in FIG. 4C, those portions of the winding 32 which connect the coils 34 will be referred to as the inter-coil connection portions 32F. The inter-coil connection portions 32F are routed along a radially outer surface of the annular connection portion 30H of the insulator 30. Consequently, in the stator 16 according to the present embodiment, the inter-coil connection portions 32F continuously connect the coils 34 (in this example, they are routed as electrical conductors continuous with the coils 34) on the second axial side of the stator core 28. Moreover, parts of the inter-coil connection portions 32F constitute pairs of cross portions 32G at locations adjacent to the respective coils 34; each pair of the cross portions 32G overlap each other in the axial direction and intersect the radial direction. With the cross portions 32G, the winding 32 is placed in a tight-wound state (i.e., in a state where tension is applied to the winding 32). Consequently, tension acts in directions in which the first and second locked portions 32D and 32E of the winding 32 are respectively fitted into the first and second winding locking portions 30E and 30F of the insulator 30.

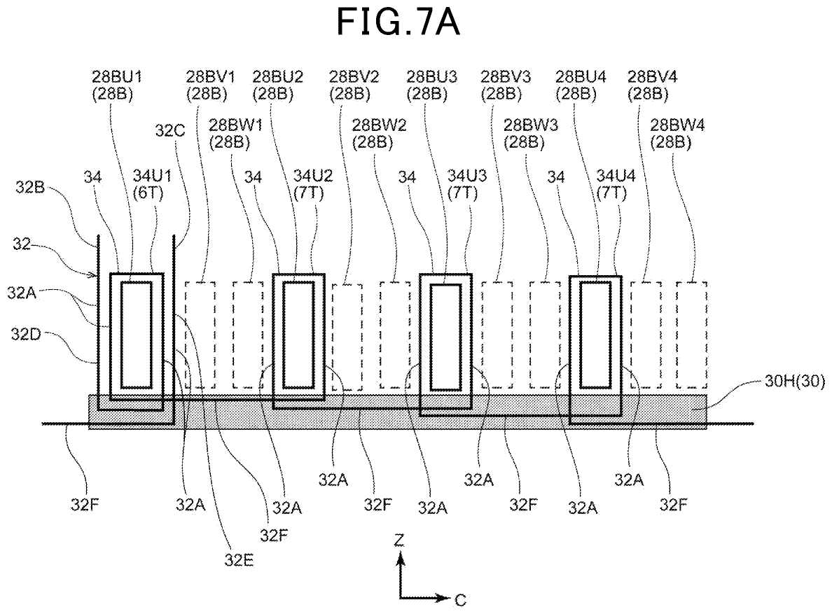

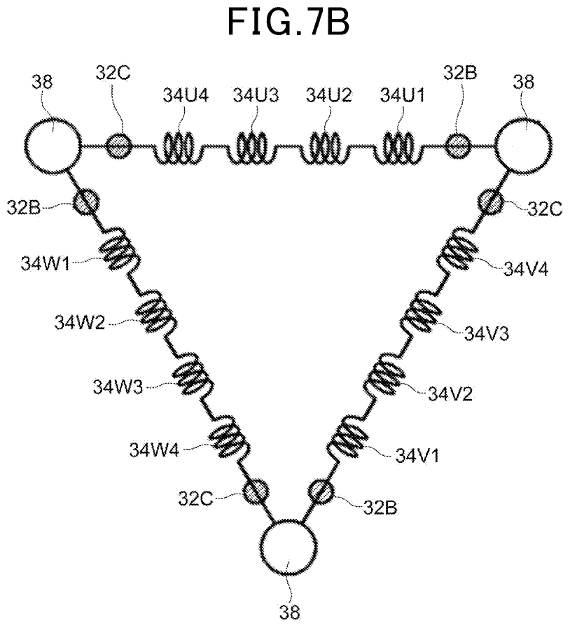

FIG. 7A is a schematic diagram showing the U-phase teeth 28B of the stator core 28 and the U-phase coils 34 formed respectively around the U-phase teeth 28B. Hereinafter, for the sake of convenience of explanation, the U-phase teeth 28B around which the U-phase coils 34 are respectively formed will be sequentially referred to as the tooth 28BU1, the tooth 28BU2, the tooth 28BU3 and the tooth 28BU4 from the second side to the first side in the circumferential direction. Similarly, the V-phase teeth 28B around which the V-phase coils 34 are respectively formed will be sequentially referred to as the tooth 28BV1, the tooth 28BV2, the tooth 28BV3 and the tooth 28BV4 from the second side to the first side in the circumferential direction. Moreover, the W-phase teeth 28B around which the W-phase coils 34 are respectively formed will be sequentially referred to as the tooth 28BW1, the tooth 28BW2, the tooth 28BW3 and the tooth 28BW4 from the second side to the first side in the circumferential direction.

Furthermore, the U-phase coils 34 formed respectively around the tooth 28BU1, the tooth 28BU2, the tooth 28BU3 and the tooth 28BU4 will be respectively referred to as the coil 34U1, the coil 34U2, the coil 34U3 and the coil 34U4 hereinafter. The coils 34U1, 34U2, 34U3 and 34U4 are formed respectively around the teeth 28BU1, 28BU2, 28BU3 and 28BU4 through the following steps.

As shown in FIGS. 5 and 7A, first, the first locked portion 32D of the winding 32 is locked to the first winding locking portion 30E of the insulator 30. After the first locked portion 32D of the winding 32 is locked to the first winding locking portion 30E of the insulator 30, the first end portion 32B of the winding 32 is in a state of being led out, from the second circumferential side of the tooth 28BU1, toward the first side in the axial direction.

Next, with the first locked portion 32D of the winding 32 locked to the first winding locking portion 30E of the insulator 30, the winding 32 is wound six turns along the bobbin portion 30A of the insulator 30 around the tooth 28BU1. It should be noted that in the drawings, 6T, which represents the number of turns of the winding 32 wound along the bobbin portion 30A of the insulator 30 around the tooth 28BU1, is added in parentheses to the end of the reference sign 34U1 designating the coil formed around the tooth 28BU1.

Next, after being routed along the annular part 28A of the insulator 30, the winding 32 is wound seven turns along the bobbin portion 30A of the insulator 30 around the tooth 28BU2. It should be noted that in the drawings, 7T, which represents the number of turns of the winding 32 wound along the bobbin portion 30A of the insulator 30 around the tooth 28BU2, is added in parentheses to the end of the reference sign 34U2 designating the coil formed around the tooth 28BU2.

Next, after being routed along the annular part 28A of the insulator 30, the winding 32 is wound seven turns along the bobbin portion 30A of the insulator 30 around the tooth 28BU3. It should be noted that in the drawings, 7T, which represents the number of turns of the winding 32 wound along the bobbin portion 30A of the insulator 30 around the tooth 28BU3, is added in parentheses to the end of the reference sign 34U3 designating the coil formed around the tooth 28BU3.

Next, after being routed along the annular part 28A of the insulator 30, the winding 32 is wound seven turns along the bobbin portion 30A of the insulator 30 around the tooth 28BU4. It should be noted that in the drawings, 7T, which represents the number of turns of the winding 32 wound along the bobbin portion 30A of the insulator 30 around the tooth 28BU4, is added in parentheses to the end of the reference sign 34U4 designating the coil formed around the tooth 28BU4.

Next, after the winding 32 is routed along the annular part 28A of the insulator 30, the second locked portion 32E of the winding 32 is locked to the second winding locking portion 30F of the insulator 30. After the second locked portion 32E of the winding 32 is locked to the second winding locking portion 30F of the insulator 30, the second end portion 32C of the winding 32 is in a state of being led out, from the first circumferential side of the tooth 28BU1, toward the first side in the axial direction.

Here, the number of the electrical conductor portions 32A of the coil 34U1 will be described. At the location where the winding 32 is wound six turns along the bobbin portion 30A of the insulator 30 around the tooth 28BU1, the number of the electrical conductor portions 32A is twelve. Moreover, the coil 34U1 includes the first locked portion 32D and the second locked portion 32E that constitute two electrical conductor portions 32A. Therefore, the number of the electrical conductor portions 32A of the coil 34U1 is fourteen.

Next, the number of the electrical conductor portions 32A of the coil 34U2 will be described. At the location where the winding 32 is wound seven turns along the bobbin portion 30A of the insulator 30 around the tooth 28BU2, the number of the electrical conductor portions 32A is fourteen. Moreover, the coil 34U2 does not include the first locked portion 32D and the second locked portion 32E that constitute two electrical conductor portions 32A. Therefore, the number of the electrical conductor portions 32A of the coil 34U2 is fourteen.

Next, the number of the electrical conductor portions 32A of the coil 34U3 will be described. At the location where the winding 32 is wound seven turns along the bobbin portion 30A of the insulator 30 around the tooth 28BU3, the number of the electrical conductor portions 32A is fourteen. Moreover, the coil 34U3 does not include the first locked portion 32D and the second locked portion 32E that constitute two electrical conductor portions 32A. Therefore, the number of the electrical conductor portions 32A of the coil 34U3 is fourteen.

Next, the number of the electrical conductor portions 32A of the coil 34U4 will be described. At the location where the winding 32 is wound seven turns along the bobbin portion 30A of the insulator 30 around the tooth 28BU4, the number of the electrical conductor portions 32A is fourteen. Moreover, the coil 34U4 does not include the first locked portion 32D and the second locked portion 32E that constitute two electrical conductor portions 32A. Therefore, the number of the electrical conductor portions 32A of the coil 34U4 is fourteen.

As described above, in the present embodiment, the numbers of electrical conductor portions 32A of the U-phase coils 34U1, 34U2, 34U3 and 34U4 are set to the same number, i.e., fourteen.

In addition, although not described in detail, the four V-phase coils 34 and the four W-phase coils 34 have the same configuration as the above-described U-phase coils 34U1, 34U2, 34U3 and 34U4.

As shown in FIG. 3A, in a state where the stator 16 has been assembled, the pair of first and second end portions 32B and 32C formed respectively at winding start and winding finish ends of the winding 32 forming the U-phase coils 34, the pair of first and second end portions 32B and 32C formed respectively at winding start and winding finish ends of the winding 32 forming the V-phase coils 34 and the pair of first and second end portions 32B and 32C formed respectively at winding start and winding finish ends of the winding 32 forming the W-phase coils 34 are led out respectively from one of the U-phase coils 34, one of the V-phase coils 34 and one of the W-phase coils 34 which are adjacent to one another in the circumferential direction. Moreover, as shown in FIG. 7B, the first end portions 32B of the windings 28, which respectively form the U-phase coils 34, the V-phase coils 34 and the W-phase coils 34, are respectively connected with the second end portions 32C of different ones of the windings 28 via three connection terminals 38. Consequently, the U-phase coils 34, the V-phase coils 34 and the W-phase coils 34 are delta-connected together.

As shown in FIG. 1, the above-described stator 16 is arranged radially inside the circumferential wall 12B of the housing 12 and fixed to the circumferential wall 12B.

### Operation and Effects According to Present Embodiment

Next, operation and effects of the motor 10 according to the present embodiment will be described.

As shown in FIG. 1, in the motor 10 according to the present embodiment described above, the stator 16 generates a rotating magnetic field, thereby causing the rotor 14 to rotate.

As shown in FIGS. 3A, 4A and 5, in the stator 16 of the motor 10 according to the present embodiment, for each of the three phases, the first end portion 32B and the second end portion 32C (i.e., a winding start end portion and a winding finish end portion) of the winding 32 forming the coils 34 of the phase are led out respectively from the second circumferential side and the first circumferential side in a same one of the coils 34 of the phase. Consequently, it becomes possible to aggregate the first and second end portions 32B and 32C of the winding 32 forming the coils 34 of the phase in a single location in the circumferential direction, in comparison with the case of configuring the first and second end portions 32B and 32C of the winding 32 forming the coils 34 of the phase to be led out respectively from different ones of the coils 34. In addition, in the present embodiment, the pairs of first and second end portions 32B and 32C of the windings 32 forming the coils 34 of the respective phases are led out respectively from three circumferentially-adjacent coils 34 belonging respectively to the three phases. Consequently, it becomes possible to aggregate the pairs of first and second end portions 32B and 32C of the windings 32 forming the coils 34 of the respective phases in the range of the three circumferentially-adjacent coils 34.

In the stator 16 of the motor 10 according to the present embodiment, the numbers of the electrical conductor portions 32A of all the coils 34 are set to the same number, i.e., fourteen. Consequently, it becomes possible to reduce vibration and noise of the motor 10 in comparison with the case of configuring the coils 34 to have different numbers of electrical conductor portions 32A.

As shown in FIGS. 3A and 4A, in the stator 16 of the motor 10 according to the present embodiment, the four U-phase core constituent parts 36, which have the respective U-phase teeth 28B on which the U-phase coils 34 are respectively formed, are connected with each other via the U-phase insulator 30. Moreover, the four V-phase core constituent parts 36, which have the respective V-phase teeth 28B on which the V-phase coils 34 are respectively formed, are connected with each other via the V-phase insulator 30. Furthermore, the four W-phase core constituent parts 36, which have the respective W-phase teeth 28B on which the W-phase coils 34 are respectively formed, are connected with each other via the W-phase insulator 30. Consequently, it becomes to facilitate the assembly work of the stator 16.

As shown in FIG. 5, in the stator 16 of the motor 10 according to the present embodiment, for each of the three phases, with the first locked portion 32D of the winding 32 of the phase locked to the first winding locking portion 30E of the insulator 30 of the phase, the first end portion 32B of the winding 32 is located at a predetermined position and the posture of the first end portion 32B is maintained. Moreover, with the second locked portion 32E of the winding 32 of the phase locked to the second winding locking portion 30F of the insulator 30 of the phase, the second end portion 32C of the winding 32 is located at a predetermined position and the posture of the second end portion 32C is maintained. With the above configuration, it becomes possible to suppress, when performing the connection work of the first and second end portions 32B and 32C of the winding 32, deformation of those parts of the winding 28 which form the coils 34.

Moreover, in the stator 16 of the motor 10 according to the present embodiment, for each of the three phases, the first and second winding locking portions 30E and 3OF of the insulator 30 of the phase, to which the first and second locked portions 32D and 32E of the winding 32 of the phase are respectively locked, are formed respectively on the two circumferential sides in the flange portion 30D of the insulator 30 (more specifically, of the first insulator part 31A). Consequently, it becomes unnecessary to have those portions of the insulator 30, to which the first and second locked portions 32D and 32E of the winding 32 are respectively locked, protruding in the axial direction; thus, it becomes possible to suppress increase in the axial dimension of the stator 16. In addition, since the postures of the first and second locked portions 32D and 32E of the winding 32 are kept along the same direction as the electrical conductor portions 32A of the coil 34 around the stator core 28, the first and second locked portions 32D and 32E themselves can also constitute electrical conductor portions 30A.

As shown in FIGS. 4A and 7A, in the stator 16 of the motor 10 according to the present embodiment, for each of the three phases, the inter-coil connection portions 32F of the winding 32 of the phase connect the coils 34 of the phase on the second axial side of the stator core 28. Moreover, as shown in FIGS. 1 and 2A, all of the inter-coil connection portions 32F of the windings 32 and the annular connection portions 30H of the insulators 30 are located on the bottom wall 12A side in the housing 12. Consequently, it becomes possible to prevent or suppress, during the assembly of the rotor 14 to the housing 12, the rotor main body 20 from making contact with the inter-coil connection portions 32F of the windings 32 or the annular connection portions 30H of the insulators 30.

As shown in FIG. 4C, in the stator 16 of the motor 10 according to the present embodiment, for each of the three phases, parts of the inter-coil connection portions 32F of the winding 32 of the phase constitute the cross portions 32G of the winding 32. Consequently, as shown in FIGS. 4C and 5, at the cross portions 32G, the winding 32 is placed in the tight-wound state (i.e., in the state where tension is applied to the winding 32), thereby preventing or suppressing loosening of the winding 32 in the range from the first locked portion 32D to the second locked portion 32E of the winding 32. Moreover, the tension generated in the winding 32 acts so that the first and second locked portions 32D and 32E of the winding 32 are respectively fitted into the first and second winding locking portion 30E and 3OF of the insulator 30. Consequently, it becomes possible to prevent or suppress detachment of the first locked portion 32D from the first winding locking portion 30E and detachment of the second locked portion 32E from the second winding locking portion 30F.

In the present embodiment, an example is given where the inter-coil connection portions 32F of the winding 32 of each phase connect, on the second axial side of the stator core 28, the coils 34 formed of the winding 32. However, the present disclosure is not limited to this example. Alternatively, depending on the configurations of the housing 12 and the rotor 14, the inter-coil connection portions 32F of the winding 32 of each phase may connect, on the first axial side of the stator core 28, the coils 34 formed of the winding 32. Moreover, in the present embodiment, an example is given where the rotor 14 has eight magnets 26 fixed to the radially outer surface of the rotor core 24. However, the present disclosure is not limited to this example. Alternatively, the rotor 14 may have a ring-shaped magnet fixed to the radially outer surface of the rotor core 24; the ring-shaped magnet has N poles and S poles arranged alternately in the circumferential direction. In this case, it is preferable that the magnet is a resin magnet (or bonded magnet).

In the present embodiment, an example is given where the first and second winding locking portions 30E and 30F of the insulator 30, to which the first and second locked portions 32D and 32E of the winding 32 are respectively locked, are formed in the flange portion 30D of the insulator 30. However, the present disclosure is not limited to this example. Alternatively, the first and second winding locking portions 30E and 30F of the insulator 30, to which the first and second locked portions 32D and 32E of the winding 32 are respectively locked, may be formed in other portions of the insulator 30. Furthermore, the insulator 30 may alternatively have only one of the first and second winding locking portions 30E and 30F formed therein, or have neither of the first and second winding locking portions 30E and 30F formed therein.

In the present embodiment, an example is given where the stator core 28 has a segmented structure including the plurality of core constituent parts 36. However, the present disclosure is not limited to this example. Alternatively, the stator core 28 may not be segmented in the circumferential direction.

In the present embodiment, an example is given where the coils 34 each having fourteen electrical conductor portions 32A are formed through the steps described with reference to FIG. 7A. However, the present disclosure is not limited to this example. The number of electrical conductor portions 32A of each of the coils 34 may be suitably set taking into account, for example, the output required of the motor 10. Hereinafter, explanation will be given of part of a manufacturing process of a stator 16 of a motor 10 according to a second embodiment; in the stator 16, the number of electrical conductor portions 32A per tooth 28B is set to 40. It should be noted that in the stator 16 of the motor 10 according to the second embodiment, members and parts corresponding to those of the stator 16 of the motor 10 according to the first embodiment will be designated by the same reference signs those of the stator 16 of the motor 10 according to the first embodiment.

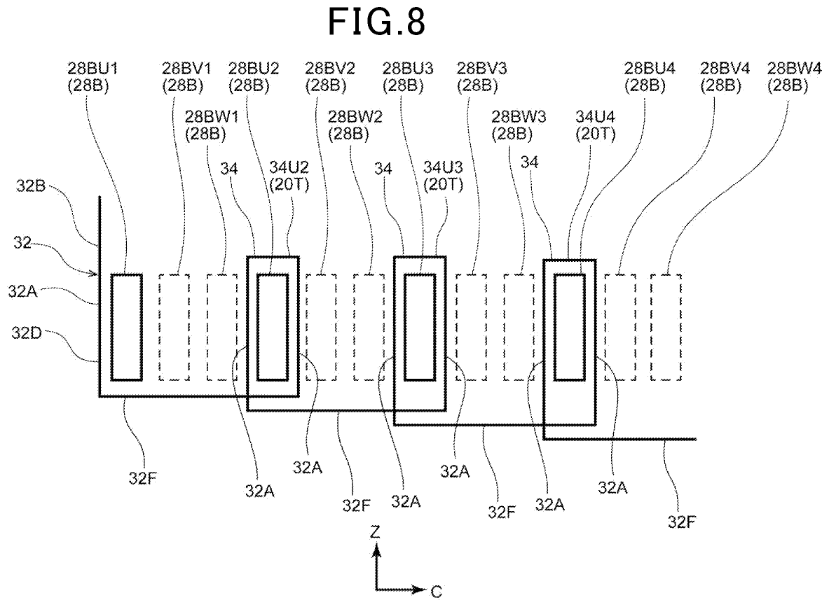

As shown in FIG. 8, in the manufacturing process of the stator 16 of the motor 10 according to the second embodiment, first, the first locked portion 32D of the U-phase winding 32 is locked to the first winding locking portion 30E of the U-phase insulator 30 (see FIG. 5). After the first locked portion 32D of the winding 32 is locked to the first winding locking portion 30E of the insulator 30, the first end portion 32B (i.e., the winding start end portion) of the winding 32 is in a state of being led out, from the second circumferential side of the tooth 28BU1, toward the first side in the axial direction.

Next, after being routed along the annular part 28A of the insulator 30, the winding 32 is wound along the bobbin portion 30A of the insulator 30 around the tooth 28BU2 by 20 turns. It should be noted that in the drawings, 20T, which represents the number of turns of the winding 32 wound along the bobbin portion 30A of the insulator 30 around the tooth 28BU2, is added in parentheses to the end of the reference sign 34U2 designating the coil formed around the tooth 28BU2.

Next, after being routed along the annular part 28A of the insulator 30, the winding 32 is wound along the bobbin portion 30A of the insulator 30 around the tooth 28BU3 by 20 turns. It should be noted that in the drawings, 20T, which represents the number of turns of the winding 32 wound along the bobbin portion 30A of the insulator 30 around the tooth 28BU3, is added in parentheses to the end of the reference sign 34U3 designating the coil formed around the tooth 28BU3.

Next, after being routed along the annular part 28A of the insulator 30, the winding 32 is wound along the bobbin portion 30A of the insulator 30 around the tooth 28BU4 by 20 turns. It should be noted that in the drawings, 20T, which represents the number of turns of the winding 32 wound along the bobbin portion 30A of the insulator 30 around the tooth 28BU4, is added in parentheses to the end of the reference sign 34U4 designating the coil formed around the tooth 28BU4.

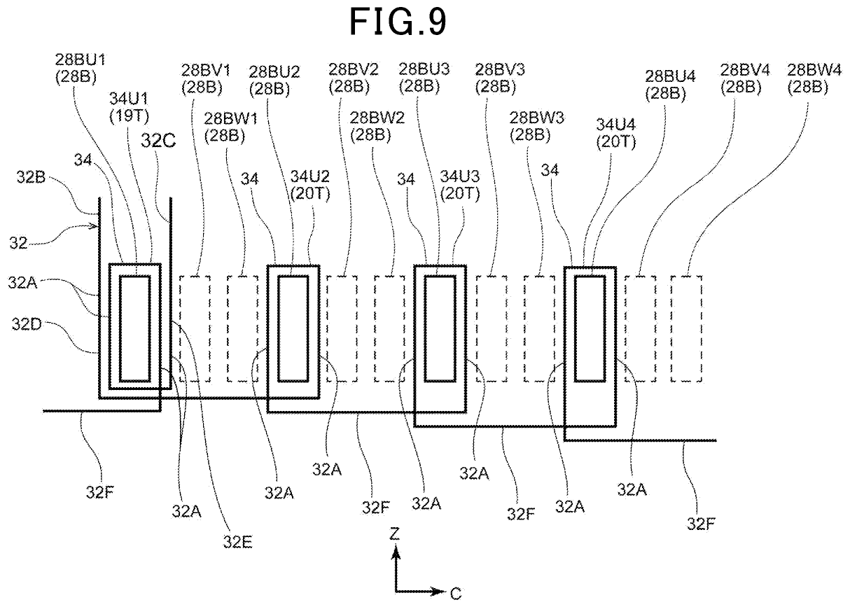

Next, as shown in FIG. 9, after being routed along the annular part 28A of the insulator 30, the winding 32 is wound along the bobbin portion 30A of the insulator 30 around the tooth 28BU1 by 19 turns. It should be noted that in the drawings, 19T, which represents the number of turns of the winding 32 wound along the bobbin portion 30A of the insulator 30 around the tooth 28BU1, is added in parentheses to the end of the reference sign 34U1 designating the coil formed around the tooth 28BU1.

Next, the second locked portion 32E of the winding 32 is locked to the second winding locking portion 30F of the insulator 30 (see FIG. 5). After the second locked portion 32E of the winding 32 is locked to the second winding locking portion 30F of the insulator 30, the second end portion 32C (i.e., the winding finish end portion) of the winding 32 is in a state of being led out, from the first circumferential side of the tooth 28BU1, toward the first side in the axial direction.

Here, the number of the electrical conductor portions 32A of the coil 34U1 will be described. At the location where the winding 32 is wound along the bobbin portion 30A of the insulator 30 around the tooth 28BU1 by 19 turns, the number of the electrical conductor portions 32A is 38. Moreover, the coil 34U1 includes the first locked portion 32D and the second locked portion 32E that constitute two electrical conductor portions 32A. Therefore, the number of the electrical conductor portions 32A of the coil 34U1 is 40.

Next, the number of the electrical conductor portions 32A of the coil 34U2 will be described. At the location where the winding 32 is wound along the bobbin portion 30A of the insulator 30 around the tooth 28BU2 by 20 turns, the number of the electrical conductor portions 32A is 40. Moreover, the coil 34U2 does not include the first locked portion 32D and the second locked portion 32E that constitute two electrical conductor portions 32A. Therefore, the number of the electrical conductor portions 32A of the coil 34U2 is 40.

Next, the number of the electrical conductor portions 32A of the coil 34U3 will be described. At the location where the winding 32 is wound along the bobbin portion 30A of the insulator 30 around the tooth 28BU3 by 20 turns, the number of the electrical conductor portions 32A is 40. Moreover, the coil 34U3 does not include the first locked portion 32D and the second locked portion 32E that constitute two electrical conductor portions 32A. Therefore, the number of the electrical conductor portions 32A of the coil 34U3 is 40.

Next, the number of the electrical conductor portions 32A of the coil 34U4 will be described. At the location where the winding 32 is wound along the bobbin portion 30A of the insulator 30 around the tooth 28BU4 by 20 turns, the number of the electrical conductor portions 32A is 40. Moreover, the coil 34U4 does not include the first locked portion 32D and the second locked portion 32E that constitute two electrical conductor portions 32A. Therefore, the number of the electrical conductor portions 32A of the coil 34U4 is 40.

As described above, in the second embodiment, the numbers of electrical conductor portions 32A of the U-phase coils 34U1, 34U2, 34U3 and 34U4 are set to the same number, i.e., 40.

In addition, although not described in detail, in the second embodiment, the four V-phase coils 34 and the four W-phase coils 34 have the same configuration as the above-described U-phase coils 34U1, 34U2, 34U3 and 34U4.

With the stator 16 of the motor 10 according to the second embodiment, it is possible to achieve the same advantageous effects as those achievable with the stator 16 of the motor 10 according to the first embodiment.

It should be noted that the number of poles, the number of coils, the number of phases, the number of serially-connected coils, the number of parallel-connected coils, etc. in the above-described motors 10 may be suitably set according to, for example, the application of the motors 10. Moreover, it also should be noted that the configurations of the above-described motors 10 can be applied to electric generators. Furthermore, it also should be noted that the configurations of the above-described stators 16 can be applied to rotors that serve as armatures according to the present disclosure.

While the above embodiments of the present disclosure have been described, it will be understood by those skilled in the art that the present disclosure is not limited to the above embodiments, but may be carried out through various modifications without departing from the spirit of the present disclosure.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

### Notes

### (First Note)

An armature (16) comprising:
an armature core (28) having a plurality of teeth (28B) arranged at intervals in a circumferential direction;
a plurality of coils (34) formed by winding an electroconductive winding (32) around each of the teeth;
inter-coil connection portions (32F) that are portions of the winding which connect the coils;
a first end portion (32B) and a second end portion (32C) which are respectively one end portion and the other end portion of the winding, the first and second end portions being led out, respectively from a second circumferential side and a first circumferential side in the coil formed around a predetermined one of the teeth, toward a first side in an axial direction; and
a plurality of electrical conductor portions (32A) that are portions of the winding which form the coils and are routed in the axial direction along the teeth, wherein the numbers of the electrical conductor portions in the respective coils are set to be equal to each other.

### (Second Note)

The armature according to the first note, wherein
the inter-coil connection portions connect, on a second side in the axial direction with respect to the armature core, the coils.

### (Third Note)

The armature according to the first note or the second note, wherein
the winding and the plurality of coils are provided for each of three or more phases, and all the coils of the three or more phases are arranged sequentially along the circumferential direction, and
the first and second end portions of the winding forming the coils of a first phase of the three or more phases and the first and second end portions of the winding forming the coils of a second phase of the three or more phases are led out respectively from one of the coils of the first phase and one of the coils of the second phase which are adjacent to each other in the circumferential direction.

### (Fourth Note)

The armature according to the third note, wherein
the armature core is segmented in the circumferential direction into a plurality of core constituent parts (36), the number of the core constituent parts being equal to the number of the coils of the three or more phases, and
those of the core constituent parts on which the coils of a same phase of the three or more phases are respectively formed are connected together by an insulator (30).

### (Fifth Note)

The armature according to the fourth note, wherein
the insulator has winding locking portions (30E, 30F) to which portions of the winding forming the coils of the same phase are respectively locked, and
the first and second end portions of the winding forming the coils of the same phase are located at predetermined positions with the portions of the winding locked respectively to the winding locking portions of the insulator.

### (Sixth Note)

The armature according to the fifth note, wherein
the insulator has a bobbin portion (30A) around which the winding is wound, and a flange portion (30D) protruding, on a radial side of the bobbin portion, toward both the first and second circumferential sides of the bobbin portion, and
the winding locking portions are formed in the flange portion.

### (Seventh Note)

The armature according to any one of the first note, the second note, and the third to sixth notes referring to the first note or the second note, wherein
parts of the inter-coil connection portions constitute pairs of cross portions (32G) at locations adjacent to the respective coils, each pair of the cross portions overlapping each other in the axial direction and intersecting a radial direction.

### (Eighth Note)

The armature according to the seventh note, wherein
the inter-coil connection portions are routed with tension generated in the inter-coil connection portions to urge the portions of the winding toward the respective winding locking portions.

### (Ninth Note)

A rotating electric machine (10) comprising:
a stator (16); and
a rotor (14),
wherein
one of the stator and the rotor includes the armature according to any one of the first to eighth notes, and the other of the stator and the rotor has a magnet (26) arranged to radially face the armature.

What is claimed is:

1. An armature comprising:
an armature core having a plurality of teeth arranged at intervals in a circumferential direction;
a plurality of coils formed by winding an electroconductive winding around each of the teeth;
inter-coil connection portions that are portions of the winding which connect the coils;
a first end portion and a second end portion which are respectively one end portion and the other end portion of the winding, the first and second end portions being led out, respectively from a second circumferential side and a first circumferential side in the coil formed around a predetermined one of the teeth, toward a first side in an axial direction; and
a plurality of electrical conductor portions that are portions of the winding which form the coils and are routed in the axial direction along the teeth, wherein the numbers of the electrical conductor portions in the respective coils are set to be equal to each other.

2. The armature as set forth in claim 1, wherein
the inter-coil connection portions connect, on a second side in the axial direction with respect to the armature core, the coils.

3. The armature as set forth in claim 1, wherein
the winding and the plurality of coils are provided for each of three or more phases, and all the coils of the three or more phases are arranged sequentially along the circumferential direction, and
the first and second end portions of the winding forming the coils of a first phase of the three or more phases and the first and second end portions of the winding forming the coils of a second phase of the three or more phases are led out respectively from one of the coils of the first phase and one of the coils of the second phase which are adjacent to each other in the circumferential direction.

4. The armature as set forth in claim 3, wherein
the armature core is segmented in the circumferential direction into a plurality of core constituent parts, the number of the core constituent parts being equal to the number of the coils of the three or more phases, and
those of the core constituent parts on which the coils of a same phase of the three or more phases are respectively formed are connected together by an insulator.

5. The armature as set forth in claim 4, wherein
the insulator has winding locking portions to which portions of the winding forming the coils of the same phase are respectively locked, and
the first and second end portions of the winding forming the coils of the same phase are located at predetermined positions with the portions of the winding locked respectively to the winding locking portions of the insulator.

6. The armature as set forth in claim 5, wherein
the insulator has a bobbin portion around which the winding is wound, and a flange portion protruding, on a radial side of the bobbin portion, toward both the first and second circumferential sides of the bobbin portion, and
the winding locking portions are formed in the flange portion.

7. The armature as set forth in claim 1, wherein
parts of the inter-coil connection portions constitute pairs of cross portions at locations adjacent to the respective coils, each pair of the cross portions overlapping each other in the axial direction and intersecting a radial direction.

8. The armature as set forth in claim 7, wherein
the insulator has winding locking portions to which portions of the winding are respectively locked, and
the inter-coil connection portions are routed with tension generated in the inter-coil connection portions to urge the portions of the winding toward the respective winding locking portions.

9. A rotating electric machine comprising:
a stator; and
a rotor,
wherein
one of the stator and the rotor includes the armature as set forth in claim 1, and the other of the stator and the rotor has a magnet arranged to radially face the armature.
